(19) United States
(12) Patent Application Publication
(10) Pub. No.: US 2012/0106632 A1
(43) Pub. Date: May 3, 2012

(54) METHOD AND APPARATUS FOR ERROR RESILIENT LONG TERM REFERENCING BLOCK REFRESH

(75) Inventors: Dazhong Zhang, Milpitas, CA (US); Xiaosong Zhou, Campbell, CA (US); Hsi-Jung Wu, San Jose, CA (US)

(73) Assignee: APPLE INC., Cupertino, CA (US)

(21) Appl. No.: 12/914,650

(22) Filed: Oct. 28, 2010

(51) Int. Cl. H04N 7/50

(52) U.S. Cl. 375/240.12; 375/E07.211

(57) ABSTRACT

A system and method for coding video data wherein a pixel block may be coded for refresh with reference to an LTR frame that was successfully transmitted, or has a high probability of having been successfully transmitted from the encoder to the decoder. Not all pixel blocks in the frame may be refreshed at the same rate. Pixel blocks containing edge details, containing a significant object, or containing foreground image data may be refreshed more often than pixel blocks containing smooth, background, or relatively less significant image data.

### BACKGROUND

Aspects of the present invention relate generally to the field of video processing, and more specifically to error resilience protocols in video coding systems.

In video coding systems, a conventional encoder may code a source video sequence into a coded representation that has a smaller bit rate than does the source video and, thereby achieve data compression. The encoder may include a pre-processor to perform video processing operations on the source video sequence such as filtering or other processing operations that may improve the efficiency of the coding operations performed by the encoder.

The encoder may additionally separate the source video sequence into a series of frames, each frame representing a still image of the video. A frame may be further divided into blocks of pixels. The encoder may then code each frame of the processed video data on a block-by-block basis according to any of a variety of different coding techniques to achieve bandwidth compression. Using predictive coding techniques (e.g., temporal/motion predictive encoding), some frames in a video stream may be coded independently (intra-coded I-frames) and some other frames may be coded using other frames as reference frames (inter-coded frames, e.g., P-frames or B-frames). P-frames may be coded with reference to a previous frame and B-frames may be coded with reference to a pair of previously-coded frames, typically a frame that occurs prior to the B-frame in display order and another frame that occurs subsequently to the B-frame in display order (Bi-directional). Reference frames may be temporarily stored by the encoder for future use in inter-frame coding.

The resulting compressed sequence (bitstream) may be transmitted to a decoder via a channel. When a new transmission sequence is initiated, the first frame of the sequence is an I-frame. Subsequent frames may then be coded with reference to other frames in the sequence by temporal prediction, thereby achieving a higher level of compression and fewer bits per frame as compared to I-frames. Thus, the transmission of an I-frame requires a relatively large amount of data, and subsequently requires more bandwidth than the transmission of an inter-coded frame.

A compressed bitstream may be received at a decoder, and original video data may be recovered from the bitstream by inverting the coding processes performed by the encoder, yielding a received decoded video sequence. In some circumstances, the decoder may acknowledge received frames and report lost frames.

Both the encoder and decoder may keep reference frames in a buffer and use another reference frame (e.g., an earlier reference frame) if a packet loss for the current reference frame is detected. However, due to constraints in buffer sizes, a limited number of reference frames can be stored in the buffer at a time. For error resilience purposes, the encoder can mark certain frames as reference frames and signal the decoder to store these frames until the encoder signals to discard them. Marked frames are known as long-term reference (LTR) frames.

Compressed video data may be transmitted in packets over the channel where channel conditions may cause packets of one or more frames to be lost. Lost packets can cause visible errors and those errors can propagate to subsequent frames if the subsequent frames are coded with reference to frames that were lost. Errors existent in or introduced into a frame may additionally be propagated through other frames that are coded with reference to the frame. Therefore, modern coding protocols often include error resilience protocols in which select frames are coded as intra-coded frames that can be decoded without reference to any other part of the video for prediction and that, therefore, would not be affected by error propagation. The intra-coded frames often are called “refresh frames.”

To facilitate frame refresh and while minimizing the transmission of high bandwidth I-frames, the cost of intra coding may be distributed over a number of frames. In this case, individual pixel block locations are intra-coded at a regular refresh rate; these pixel blocks are called “refresh” pixel blocks. Although a portion of the pixel blocks of a frame may be refreshed with intra-coded blocks, the rest of the frame may be coded as inter-coded blocks. This technique can distribute the bandwidth expense of the error resilience protocol but it has other consequences. When an I-coded refresh pixel block is decoded and displayed adjacent to other inter-coded pixel blocks, it may cause a visual disparity. The refreshed block was coded without reference to any other frames and, therefore, may have brightness levels or other display characteristics that are different from the predictively coded pixel blocks of the same frame. This may induce flickering artifacts on decode.

Accordingly, there is a need in the art for a video encoding system capable of rapidly recovering from packet loss without adding significantly to the bandwidth being used to transmit the video data over the channel and without introducing visible artifacts to the video image.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified block diagram illustrating components of an exemplary video coding system according to an embodiment of the present invention.

FIG. 2 is a simplified block diagram illustrating components of an exemplary video encoder according to an embodiment of the present invention.

FIG. 3 is a simplified flow diagram illustrating a method of encoding video frames according to an embodiment of the present invention.

FIG. 4 is a simplified flow diagram illustrating a method of encoding video frames according to an embodiment of the present invention.

FIG. 5 is a simplified flow diagram illustrating a method of encoding video frames according to an embodiment of the present invention.

FIG. 6 is a simplified flow diagram illustrating a method of selecting a block for refresh according to an embodiment of the present invention.

FIG. 7 is a simplified flow diagram illustrating a method of selecting an LTR frame for refresh according to an embodiment of the present invention.

FIG. 8 is a simplified block diagram illustrating components of an exemplary video decoder according to an embodiment of the present invention.

### DETAILED DESCRIPTION

Embodiments of the present invention provide an error resilience protocol in a video coding system in which pixel blocks subject to refresh may be coded predictively with reference to long term reference (“LTR”) frames stored by an encoder and a decoder. Refreshing pixel blocks with reference to LTR achieves error resilience as with other protocols but at increased efficiency due to use of predictive coding techniques. Because the refresh blocks may be coded using an acknowledged LTR frame, the protocol provides resilience against transmission errors. The LTR frame is “known” to be decoded and stored successfully at the decoder. Even when a transmission error occurs that causes loss of synchronization between an encoder and a decoder, the decoder can begin recovery from the transmission error upon receipt and decoding of a refresh pixel block.

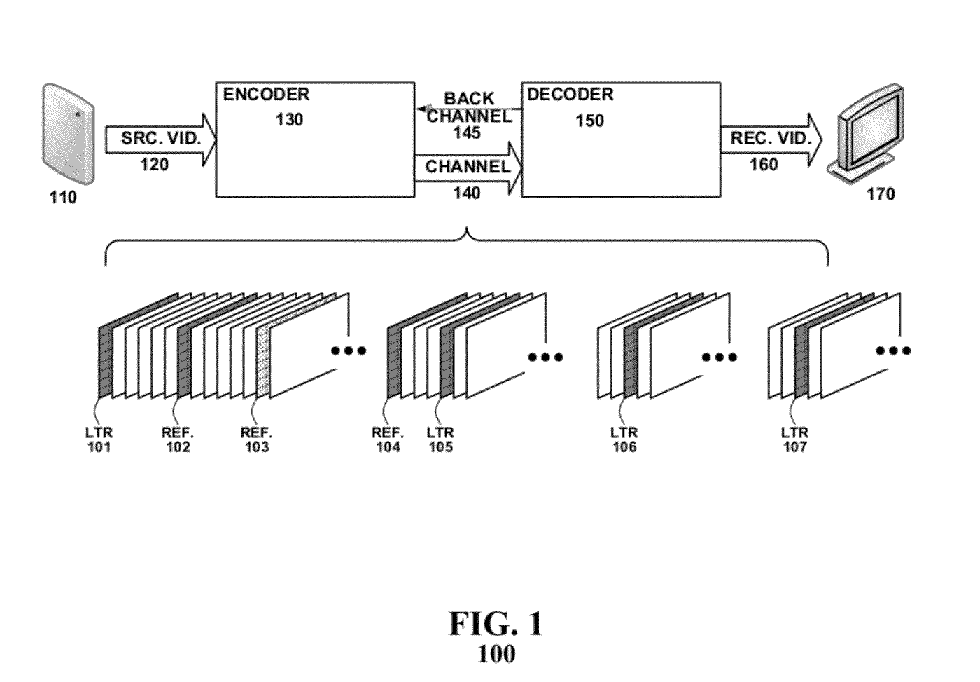

FIG. 1 is a simplified block diagram illustrating components of an exemplary video coding system 100 according to an embodiment of the present invention. As shown, the video coding system 100 may include an encoder 130 and a decoder 150. The encoder 130 may receive an input source video sequence 120 from a video source 110, such as a camera or storage device. As will be further explained, the encoder 130 may then process the input source video sequence 120 as a series of frames.

Using predictive coding techniques, the encoder 130 may compress the video data using a motion-compensated prediction technique that exploits spatial and temporal redundancies in the input source video sequence 120. The encoder 130 may output coded video data to a channel 140 wherein the coded video data may occupy less bandwidth than the source video sequence 120. The channel 140 may be a transmission medium provided by communications or computer networks, for example either a wired or wireless network.

In the process of coding the processed frames, the encoder 130 may develop prediction references among frames according to motion detection between the frames. In the course of coding frames, the encoder 130 may assign certain frames 101-107 to serve as reference frames for prediction. The decoder 150, responsive to such assignments, may decode the reference frames 101-107 and output them for display. The decoder 150 also may store the decoded reference frames for use in decoding later-coded frames.

The encoder 130 also may assign certain of the reference frames 101, 105, 106 and 107 to be long-term reference (“LTR”) frames. The LTR frames are reference frames that are acknowledged by the decoder via a back channel 145. Decoded LTR frames may be stored by the decoder 150 just as other non-LTR reference frames 102, 103, 104 would be and may be used as sources of prediction for other frames that will be coded subsequent to the LTR frame. When an LTR frame is successfully decoded, the decoder 150 may send an acknowledgement message to the encoder 130 identifying successful decode. Upon receipt of the acknowledgement message, an encoder may record a status indicator indicating that the LTR frame was successfully processed at the decoder. Acknowledgement messages are not transmitted for non-LTR reference frames (say 102) and, therefore, the encoder 130 will receive no indicator of successful receipt by the decoder 150 even when the decoder receives the non-LTR reference frame 102 without error.

In an embodiment, the encoder 130 and decoder 150 may operate according to a coding protocol that employs motion compensated prediction for pixel blocks that are coded for error resilience. Under this protocol, each frame may be parsed into a predetermined number of “pixel blocks,” regular arrays of pixels (typically, 8×8 or 16×16 pixel arrays). The error resilience protocol may mandate that each pixel block location must be refreshed at least once within a predetermined number of frames (for example, once per 10 frames, once per 30 frames). When the pixel block is to be refreshed, the encoder may code the pixel block under motion compensation using only the currently-active LTR frames. When a pixel block is not to be refreshed, the encoder is free to code the pixel block under motion compensation, using any reference frame available to it.

By coding refresh pixel blocks predictively using LTR frames as sources of prediction, the coding protocol is expected to achieve more efficient coding than prior solutions that would have coded the refresh pixel block as I blocks. Predictive coding techniques generally yield improved coding efficiencies over I-coding techniques and, therefore, can code a pixel block with reduced bandwidth. A predictively coded pixel block, when decoded, is likely to have similar visual characteristics to neighboring pixel blocks that are not coded for error resilience purposes and, therefore, flickering and other visual artifacts may be avoided. Thus, the present techniques are expected to achieve the goals of error resilience coding policies but at reduced bandwidth and better rendered image quality.

The decoder 150 may receive the compressed video data from the channel 140 and prepare the video for the display 170. Upon receipt of a frame, the decoder 150 may decode the frame by inverting coding operations performed by the encoder 130, and determine whether packets of the frame have been lost. If no transmission errors have occurred, the decoder 150 may decode coded video data and output it to a display. The decoder 150 further may store decoded reference frame data, including LTR frames, to local memory (not shown). If an LTR frame is received without errors, the decoder 150 may send an acknowledgement message indicating the successful receipt to the encoder 130 via back-channel 145. The operations performed by the decoder 150 to invert the coding operations performed by the encoder 130 may include decompressing the coded video signals using LTR frames temporarily stored at the decoder 150. The processed video data 160 may then be displayed on a screen or other display 170. Alternatively, it may be stored in a storage device (not shown) for later use.

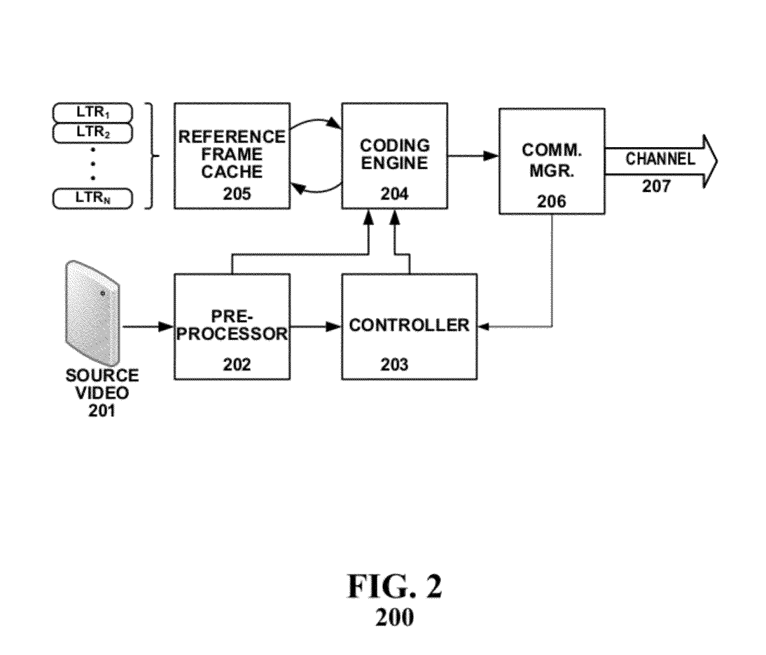

FIG. 2 is a simplified block diagram illustrating components of an exemplary video encoder 200 according to an embodiment of the present invention. As shown, encoder 200 may include a pre-processor 202, a controller 203, a coding engine 204, a reference frame cache 205, and a communications manager 206.

The pre-processor 202 may perform video processing operations to condition the source video sequence 201 to render bandwidth compression more efficient or to preserve image quality in light of anticipated compression and decompression operations. The pre-processor 202 additionally may separate the source video sequence 201 into a series of frames, if not already done, each frame representing a still image of the video.

The controller 203 may govern operation of the pre-processor 202 and/or coding engine 204. In this regard, it may receive data from the pre-processor 202 and/or coding engine 204, identifying characteristics of video content within the video sequence. For example, the controller 203 may receive indicators of motion among the frames from pre-processor 202 or indicators of motion among pixel blocks from the coding engine 204. The controller 203 may receive indicators of image brightness and frame-to-frame variations thereof from the pre-processor 202.

The controller 203 may assign coding types to individual frames from the video sequence (e.g., whether individual frames are to be coded as I-pictures, P-pictures or B-pictures). According to an embodiment of the present invention, the controller 203 additionally selects frames within the video sequence to be coded as reference pictures or LTR frames. Further, the controller 203 may select pixel blocks from within the sequence to be coded as refresh pixel blocks.

The coding engine 204 may receive the processed video data from the pre-processor 202. The coding engine 204 may operate according to a predetermined protocol, such as H.263, H.264, or MPEG-2. In its operation, the coding engine 204 may perform various compression operations in accordance with the parameters received from the controller 203, including predictive coding operations that exploit temporal and spatial redundancies in the source video sequence 201. The coded video data, therefore, may conform to a syntax specified by the protocol being used, and may then be passed to the communications manager 206 and then output on channel 207 for transmission to a decoder.

The communications manager 206 coordinates the output of the coded video data to the communication channel 207. The communications manager 206 may additionally provide feedback to the controller 203 regarding channel conditions including information concerning any buffer delay or buffer overflow, data packets or LTR frames acknowledged as successfully received at the decoder, notifications of dropped or lost packets, etc. The controller 203 may then use this feedback to dynamically adjust the target bit rate for the encoder 200. Channel 207 may then deliver the coded video data output from the coding engine 204 to a decoding engine.

The reference picture cache 205 may store frame data that may represent sources of prediction for later-received frames input to the video coding system. The reference frame cache 205 may store both LTR frames and non-LTR frames that may be used as reference frames for inter-coding other frames or blocks. To that end, the coding engine 204 may include a decoder (not shown in FIG. 2) that decodes coded video generated by the coding engine 204 and may store the decoded video data in the reference picture cache 205. Thus, the reference picture cache 205 of the encoder 200 may store decoded reference frames that will be obtained by a decoder (FIG. 1) when it decodes the coded video data.

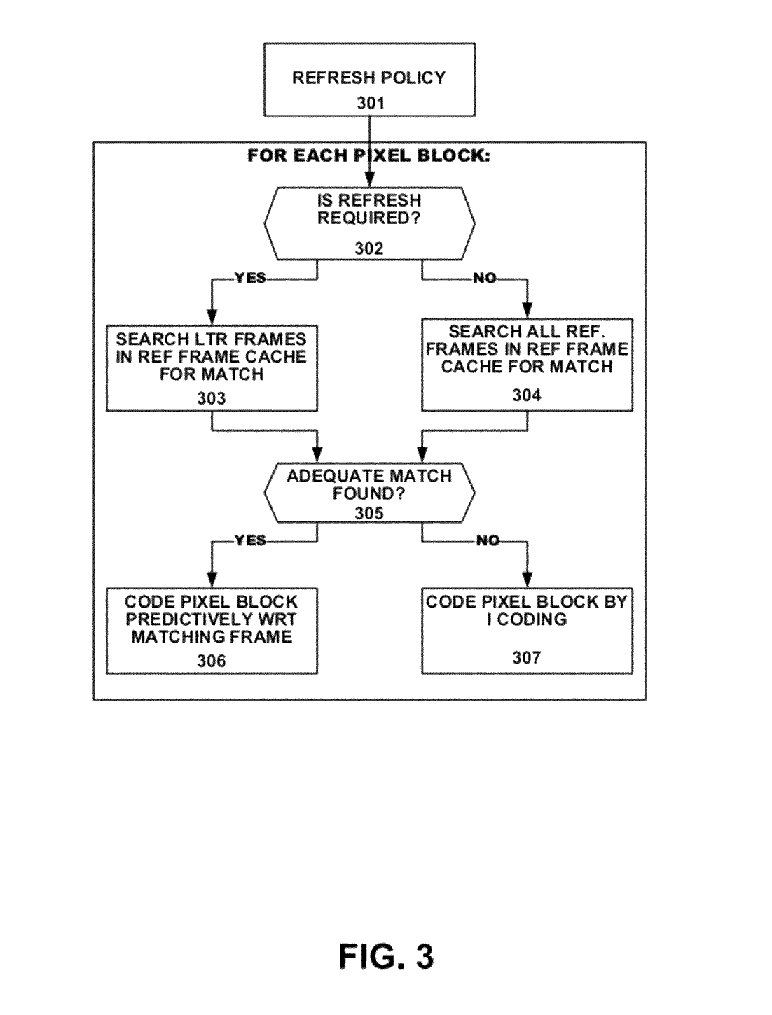

FIG. 3 illustrates a method 300 of encoding video according to an embodiment of the present invention. The method may proceed on a pixel block-by-pixel block basis across a frame. The method 300, with reference to an error resilience policy may determine whether the current pixel block is to be coded as a refresh pixel block (blocks 301, 302). If the current pixel block is to be coded as a refresh pixel block, then the current pixel block may be coded predictively but only with respect to LTR frames stored in the reference picture cache. In this mode, the method 300 may search among the LTR reference frames currently stored in the reference picture cache for a match to the current pixel block (block 303). If the pixel block need not be coded as a refresh pixel block, the pixel block may be coded according to a default motion prediction mode in which any reference frame stored in the reference picture cache may serve as a source of prediction for the current pixel block. Under this default mode, the method 300 may search among all reference frames currently stored in the reference picture cache for a match to the current pixel block (block 304).

Following operation of blocks 302 or 304, the method 300 may determine whether the best-matching pixel block in the selected frame identified from the reference picture cache is an adequate source of prediction for the current pixel block (block 305). To make such a determination, the method may compare content of the reference pixel block to that of the current pixel block to estimate a level of prediction error that would be obtained thereby and may compare the estimated error to a threshold. If comparison determines that the reference pixel block is an adequate source of prediction, the method 300 may cause the current pixel block to be coded predictively with reference to the matching reference pixel block (block 306). If the comparison determines that the reference pixel block is an inadequate source of prediction, the method may cause the current pixel block to be coded by intra-coding (block 307).

Thus, under the method 300, refresh pixel blocks may be coded predictively with reference to LTR frames stored in the reference picture cache.

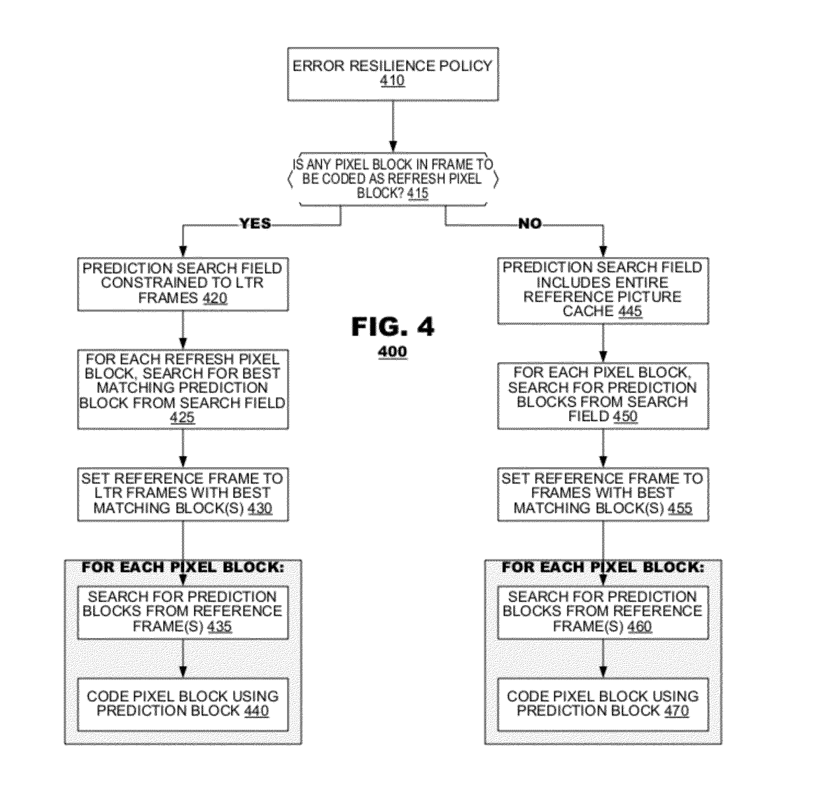

FIG. 4 illustrates a method 400 according to another embodiment of the present invention. The method 400 may operate with reference to an error resilience policy (block 410). During coding of a new frame, the method 400 may determine at the outset whether any pixel block of the frame is to be coded as a refresh pixel block (blocks 410, 415). If so, the method 400 may constrain the search field of the frame to LTR frames stored in the reference picture cache (block 420). The method 400 may identify, for each refresh pixel block to be coded, stored LTR frames that provide a source of prediction for the pixel block (block 425). The method 400 may set the identified LTR frames as candidate reference frames for the coding of the frame (block 430). Thereafter, the method 400 may code each pixel block of the frame predictively, using the candidate reference frames as sources of prediction for the pixel blocks (blocks 435, 440).

If no pixel block is to be coded as a refresh frame, then the coding operation may proceed according to default procedures, using all frames of the reference picture cache as a search field (block 445). The default procedures may include searching the reference picture cache for candidate reference frames for each pixel block (block 450) and setting the candidate reference frames based on results of the search (block 455). The default procedures further may include searching for pixel blocks, from among the candidate reference frames, that are to be used as sources of prediction for the pixel blocks (block 460), then coding the pixel blocks using the reference pixel blocks (block 465).

Conventionally, many modern coding environments establish limits for the number of reference frames that a single frame may use as sources of prediction. For example, a single P-frame may be constrained to reference a single reference frame as a source of prediction. The method of FIG. 3 finds application where there is no such limit and an encoder is free to select arbitrarily from among multiple LTR frames (block 303) or reference frames (block 304) to identify a best reference pixel block for coding. The method of FIG. 4 may find application in different coding environments where the number of reference frames that can be used to code a single frame is constrained to a predetermined limit. In such systems, blocks 420-430 may identify the reference frame(s) that are to be used to code a new frame when the error resilience policies require that at least one pixel block is coded as a refresh pixel block.

During operation of the method 400, when multiple refresh pixel blocks occur in a single frame, it may occur that the operation of blocks 420-430 may identify a number of reference frames that exceed the limit imposed by the governing coding protocol. In such a case, the method 400 may reduce the number of reference frames selected (operation not shown) by minimizing prediction errors that otherwise would arise when LTR frames are eliminated from consideration.

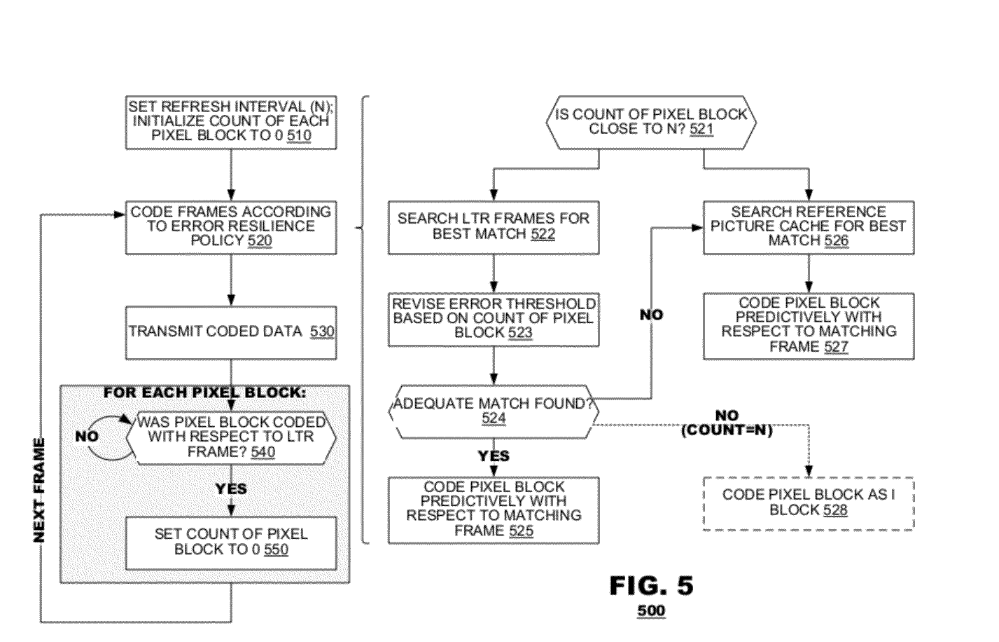

FIG. 5 illustrates another method 500 according to an embodiment of the present invention. In this embodiment, an encoder maintains a running refresh counter for each pixel block location in the video sequence, resetting is dynamically based on coding decisions made with respect to LTR frames. The method may begin by establishing a programmable refresh interval of N frames and initializing a counter for each pixel block (block 510). Typically, the refresh interval corresponds to a desired recovery time in the invent of transmission errors. For example, when video is coded at 30 frames per second, a refresh interval of N=30 would require every pixel block location to be refreshed at least once every 30 frames.

The method may code frames according to the error resilience policy (block 520) and may transmit coded data obtained thereby to a decoder (block 530). During coding operations, various pixel blocks may be selected as refresh pixel blocks and may be coded with respect to LTR frames. Various other pixel blocks also may be coded predictively with respect to LTR frames even though such pixel blocks were not yet assigned to be refresh pixel blocks. According to an embodiment, the method 500 may survey the pixel blocks of the coded frame and determine, for each pixel block, was the pixel block coded with respect to an LTR frame (block 540). If so, the encoder may reset the counter of the respective pixel block (block 550). The counters of pixel blocks that were not coded with respect to LTR frames may remain unchanged. Thereafter, the method 500 may advance to the next frame and repeat operation until the video sequence is consumed.

The embodiment of FIG. 5 may leverage coding decisions made by dynamic prediction selections made within the coding process. During operation, if the coding process selects an LTR to be a source of prediction for a pixel block that is not yet due to be refreshed, the coding process's selection effectively operates as an early refresh of the pixel block. The decoder already stores a copy of the LTR frame in its reference picture cache and, therefore, all pixel blocks that depend from the LTR frame effectively are refreshed even though the error resilience protocol did not schedule them for refresh. Thus, it is proper to reset the refresh counters for all pixel blocks that depend from the LTR frame.

During coding, it may occur that, as refresh counters are reset due to operation of the coding process, the refresh counters of the various pixel blocks may exhibit a cadence in which a relatively large number of pixel blocks are in unison and, therefore, will exceed a refresh limit simultaneously. According to an embodiment, in such circumstances, counters may be reset to random values at various points in operation to break up any such cadences that may develop. Similarly, at initialization, the refresh counters may be randomized to distribute refresh pixel blocks temporally within the video sequence.

FIG. 5 also illustrates operations that may occur during frame coding, in an embodiment. During coding, the method 500 may determine, for each pixel block, whether the pixel block's refresh count is close to the refresh limit N (block 521). If so, the method 500 may search the LTR frames within the reference picture cache for a pixel block that best matches the pixel block (block 522). The method 500 further may revise an error threshold based on the refresh count value of the pixel block (block 523). Using the revised error threshold, the method 500 may determine whether the best matching LTR pixel block is an adequate match for the pixel block being coded (block 524). If so, the method 500 may code the pixel block predictively with respect to the matching LTR frame (block 525).

If the best-matching LTR pixel block is not an adequate match, the method 500 may advance to block 526 and search the remainder of the reference picture cache—the non-LTR reference frames—for a match to the pixel block. Further, the method 500 may advance to block 526 if it determines at block 521 that the refresh count value is not close to N. The method 500 may code the pixel block with reference to the best matching pixel block within the reference picture cache (block 527).

In an embodiment, if at block 524 no adequate match was found, the method 500 may determine to code the pixel block by intra-coding (block 528).

Operation of blocks 521-527 advantageously provide a weighted selection process in which the method 500 attempts to find a good match between a pixel block location and the LTR frames as the pixel block's refresh counter draws near to the refresh limit N. The method may attempt to find a good match among LTR frames and estimate the prediction error that arises between the input pixel block and the best-matching LTR frame. If the error exceeds a threshold, the method 500 may defer the attempt until another frame and allow the pixel block to be coded with reference to any frame in the reference picture cache. As the refresh count value approaches the limit, however, the error threshold may be revised to allow increasing larger amounts of prediction error. Ultimately the error threshold may be set to a limitless value if the refresh count matches N, the refresh limit.

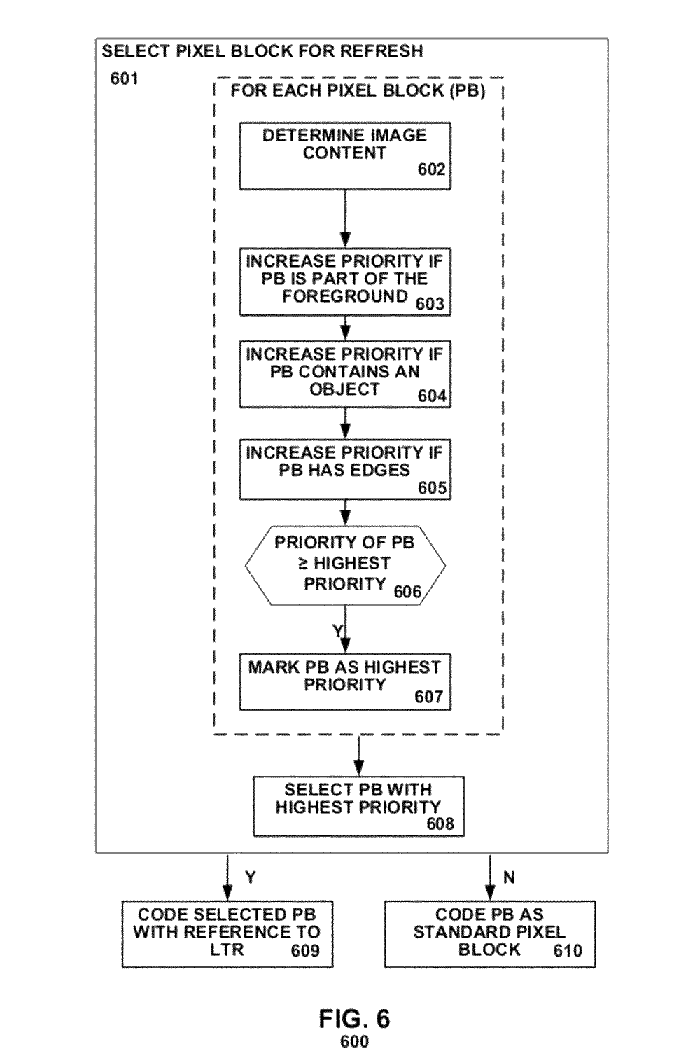

FIG. 6 is a simplified flow diagram illustrating a method of selecting a block for refresh according to an embodiment of the present invention. Not all pixel blocks in a frame may require refresh at the same rate. Where there are no pixel blocks in a frame with a refresh count close to the refresh limit, a pixel block may be selected for refresh based on the image content of the pixel block. As such, a priority may be set for each pixel block based on the image content of the pixel blocks and a pixel block having the highest refresh priority in the refresh frame may be selected as a refresh pixel block. The remaining lower priority pixel blocks in the refresh frame may be coded as standard pixel blocks.

At block 601, a pixel block may be selected for refresh by determining a priority based on the image content for each pixel block. In an embodiment, the probable image content of each pixel block may be determined by a controller based on feedback from the pre-processor and coding engine (block 602). For example, the controller may receive indicators of motion among the frames from pre-processor, indicators of motion among pixel blocks from the coding engine or indicators of image brightness and frame-to-frame variations thereof from the pre-processor. Based on these received indicators, the controller may identify edges, significant objects, or background regions in the processed frames. Priority of a pixel block may then be determined based on the probable or evaluated image content of the pixel block as identified by the controller. For example, a pixel block with image content that is part of the foreground may benefit from refresh more regularly than a pixel block with image content that is part of the background and may consequently have a higher priority than a pixel block having image content that part of the background. Therefore, at block 603, pixel blocks with image content that is part of the foreground may be determined to have an increased priority.

Similarly, a pixel block with image content that is part of a significant object may benefit from refresh more regularly than a pixel block with image content that is smooth or plain or otherwise lacking a significant object and may consequently have a higher priority than a pixel block having smooth or unspecified image content. Therefore, at block 604, pixel blocks with image content that contains a significant object, a face for example, may be determined to have an increased priority.

Pixel blocks with image content that is smooth or edge free may be refreshed at the decoder through interpolation from a recently refreshed neighboring pixel block rather than from refresh frames transmitted form the encoder. Then a pixel block with image content that contains edges may benefit from refresh more regularly than a pixel block without edges in a smooth, edge free zone and may consequently have a higher priority than a pixel block having smooth or otherwise edge-free image content. Therefore, at block 605, pixel blocks with image content that contains edges may be determined to have an increased priority.

There may be other methods for determining or increasing the refresh priority for a pixel block. In an embodiment, the priority of a pixel block may be determined by the position of the pixel block in the frame, such that pixel blocks in the center of the frame are refreshed more regularly than pixel blocks along the edge of the frame. In another embodiment, the frame may be further separated into slices, then on a slice-by-slice basis, a pixel block from a slice may be selected for refresh.

After a priority has been determined for each pixel block, the pixel block with the highest priority may be determined at block 606 and marked as the best candidate for refresh at block 607. If two pixel blocks have the same priority, the pixel block with the refresh count closest to the refresh limit may be selected as the best pixel block for refresh. Then, at block 609, the selected pixel block may be coded as a refresh pixel block with reference to a suitable LTR frame. The remaining blocks may be coded as standard pixel blocks at block 610 with reference to a suitable reference frame selected from the reference frame cache as described above.

Thus, under the method 600, refresh pixel blocks may be coded in the order of a priority based on the detected image content of each pixel block.

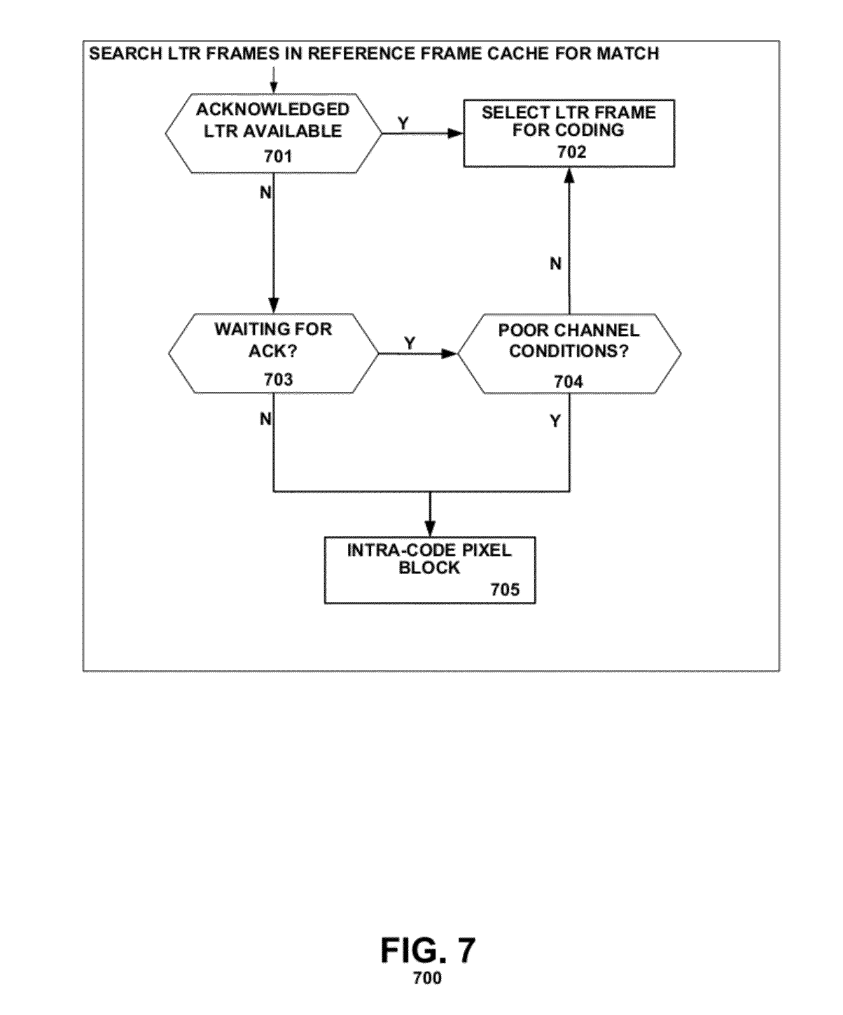

FIG. 7 is a simplified flow diagram illustrating a method for selecting an LTR frame for coding a refresh pixel block according to an embodiment of the present invention. To code a pixel block for refresh, the reference frame cache of the encoder may be searched for a suitable LTR frame with which to predictively code the refresh pixel block to achieve data compression. Preliminarily, the reference frame cache may be searched for an appropriate LTR frame that may have been acknowledged by the decoder as successfully received at block 701. An LTR frame that has been acknowledged as successfully received by the decoder may be selected as the reference frame for inter-coding the selected pixel block for refresh at block 702.

If there is a significant delay between acknowledgements, the controller may still be waiting for an acknowledgement from the decoder or the acknowledgement may have been dropped despite that the LTR frame may have been successfully received by the decoder (block 703). The probability of whether that frame was part of a packet loss may then be estimated by the controller at block 704. The controller may determine that the LTR frame was successfully received at the decoder based on feedback about the channel conditions from the communications manager including information concerning any buffer delay or buffer overflow, the number of data packets or LTR frames acknowledged as successfully received at the decoder as compared to the notifications of dropped or lost packets, etc. If, at block 704, it is determined that there is a suitable unacknowledged LTR frame with a low risk of loss, that frame may be selected as the reference frame for inter-coding the selected pixel block for refresh at block 702.

Other factors may be considered relevant to determine risk of loss at block 704. For example, if the LTR frame is large, the controller may identify the risk of loss is greater than if the designated LTR frame is small regardless of the channel conditions. If forward error correction is implemented, the risk of loss may be considered low where the LTR frame may be recoverable.

If at block 703 the communications manager is not waiting for an acknowledgement from the decoder, or, if at block 704, it is determined that the risk of loss is high, there may not be an appropriate LTR frame available for inter-coding the pixel block. Then the selected pixel block may be intra-coded and the I-block used for refresh at block 705.

Other factors may be considered when selecting an LTR frame. For example, in an embodiment, once a suitable LTR frame is selected for a pixel block in a slice, every other pixel block in the slice may be refreshed using the same LTR frame.

Thus, under the method 700, refresh pixel blocks may be coded predictively with reference to acknowledged LTR frames or LTR frames that have not been acknowledged but have a high probability of having been successfully transmitted to the decoder.

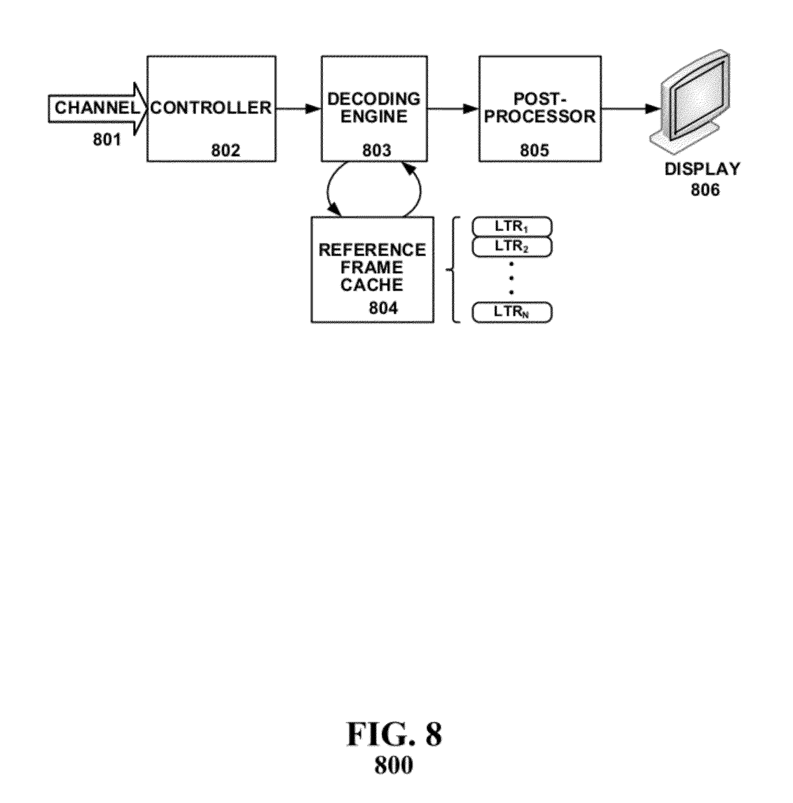

FIG. 8 is a simplified block diagram illustrating components of an exemplary video decoder 800 according to an embodiment of the present invention. Decoder 800 may include a controller 802, a decoding engine 803, a reference frame cache 804, and a post-processor 805. Post-processor 805 may prepare the video data for the display 806. This may include further filtering, de-interlacing, or scaling the received video.

The controller 802 may receive a coded video signal from a communication channel 801 and may send an acknowledgement back to the encoder upon receipt of a reference frame. Then the coded video data may be passed to the decoding engine 803. The decoding engine 803 may then parse the coded video data to recover the original source video data, for example, by decompressing the coded video data. In an embodiment, decoding may include refreshing pixel blocks in a smooth, edge free area by interpolating the neighboring pixel blocks when a refresh pixel block in the edge free area is received.

The reference frame cache 804 may store frame data previously decoded that may be used as prediction references for other frames to be recovered from later-received coded video data. The reference frame cache 804 may store LTR frames or other frames that may be used as reference frames for inter-coding. The encoder may communicate to the decoder 800 which frames should be stored or removed from LTR storage.

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 2 illustrates the components of the encoder 200, including the pre-processor 202 and the controller 203 as separate units, in one or more embodiments, they may be integrated and they need not be separate units. Such implementation details are immaterial to the operation of the present invention unless otherwise noted above. Additionally, it is noted that the arrangement of the blocks in FIGS. 6 and 7 do not necessarily imply a particular order or sequence of events, nor are they intended to exclude other possibilities. For example, the operations depicted at blocks 603 through 606 or at blocks 701, 703 and 704 may occur substantially simultaneously with each other.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A video coding method, comprising:
determining, with reference to an error resiliency policy, whether a pixel block in a frame is to be coded as a refresh pixel block;
if the pixel block is to be coded as a refresh pixel block, coding the pixel block according to predictive techniques with reference to a stored long term reference (LTR) frame; and
if the pixel block is not to be coded as a refresh pixel block, coding the pixel block according to predictive coding techniques with reference to a reference frame.

2. The method of claim 1, wherein the error resiliency mandates that each pixel block location in a frame area is to be coded as a refresh pixel block at a predetermined refresh rate.

3. The method of claim 2, further comprising increasing the refresh rate of a given pixel block location based on image content of the given pixel block.

4. The method of claim 2, further comprising increasing the refresh rate of a given pixel block location when the given pixel block contains an edge.

5. The method of claim 2, further comprising increasing the refresh rate of a given pixel block location when the given pixel block contains an object.

6. The method of claim 2, further comprising increasing the refresh rate of a given pixel block location when the given pixel block contains image content classified as foreground content.

7. The method of claim 1, further comprising:
storing according to the error resiliency policy, a refresh counter for each pixel block location in a frame area, wherein the determining includes evaluating a refresh counter for the pixel block;
after the frame is coded, identifying the pixel block(s) that have been coded predictively with reference to an LTR frame; and
resetting the refresh counters of the identified pixel block(s).

8. A video decoding method, comprising:
upon reception of coded video data representing a long term reference (LTR) frame,
decoding the coded LTR frame data,
storing the decoded LTR frame data, and
transmitting an acknowledgement of the coded LTR frame data to an encoder;
upon reception of coded video data representing a frame containing coded refresh pixel blocks, the refresh pixel blocks selected according to an error resiliency policy, decoding the coded refresh pixel blocks according to predictive decoding techniques, using the stored LTR frame data as a source of prediction.

9. The method of claim 8, wherein if a refresh pixel block is in an edge-free area of the frame, refreshing a neighboring pixel block in the edge-free area by interpolating the neighboring pixel block from the refresh pixel block.

10. A coded video signal, generated according to a process, comprising:
for each pixel block in a frame, determining, with reference to an error resiliency policy, whether the respective pixel block is to be coded as a refresh pixel block;
if the pixel block is to be coded as a refresh pixel block, coding the pixel block according to predictive techniques with reference to a stored long term reference (LTR) frame;
if the pixel block is not to be coded as a refresh pixel block, coding the pixel block according to predictive coding techniques with reference to a reference frame; and
transmitting the coded frame data from an encoder on a physical data path.

11. A video coding method, comprising:
for each pixel block of a frame, determining, with reference to an error resiliency policy, a refresh count of the respective pixel block;
if the refresh count value is close to a maximum refresh value of the error resiliency policy, searching among locally stored LTR frames for a stored pixel block to be used for predictive coding of the respective pixel block;
if the stored pixel block adequately matches the respective pixel block, coding the respective pixel block using the stored pixel block as a prediction reference; and
if the stored pixel block does not adequately match the respective pixel block, coding the respective pixel block using a stored pixel block of another reference frame as a prediction reference.

12. The coding method of claim 11, further comprising, if the refresh count value is not close to a maximum refresh value, searching among all locally-stored reference frames for a pixel block that matches the respective pixel block and coding the respective pixel block with reference to the stored pixel block identified therefrom.

13. The coding method of claim 11, wherein the refresh count value is determined to be close to the maximum refresh value if it is within a predetermined number of the maximum refresh value.

14. The coding method of claim 11, wherein the stored pixel block is determined to adequately match the respective pixel block in response to an estimate of prediction errors obtained from the stored pixel block and the respective pixel block.

15. The coding method of claim 14, further comprising comparing the error estimate is to an error threshold.

16. The coding method of claim 15, wherein the error estimate varies based on a difference between the refresh count value of the respective pixel block and the maximum refresh value.

17. The coding method of claim 11, further comprising, following coding of the frame, resetting refresh count values of all pixel blocks that have been coded with reference to an LTR frame.

18. A video coding method, comprising:
selecting a pixel block in a frame to be coded as a refresh pixel block;
determining if an LTR frame is available for use in coding the pixel block; and
coding the remaining frame according to predictive coding techniques;
wherein if an LTR frame is available, using the LTR frame as a reference for coding the pixel block according to predictive coding techniques.

19. The method of claim 18 wherein if an LTR frame is not available, coding the pixel block as an I-block.

20. The method of claim 18 wherein the selected pixel block is refreshed more often than a second pixel block in the frame.

21. The method of claim 18 wherein multiple LTR frames are selected for coding the pixel block.

22. The method of claim 18, wherein the first pixel block is selected as a refresh pixel block in part because the first pixel block's image content contains edges.

23. The method of claim 18, wherein the first pixel block is selected as a refresh pixel block in part because the first pixel block's image content contains an object.

24. The method of claim 18, wherein the first pixel block is selected as a refresh pixel block in part because the first pixel block's image content is classified as foreground content.

25. The method of claim 18, wherein the LTR frame is a frame that has been acknowledged as successfully received by a decoder.

26. The method of claim 18, wherein the LTR frame is a frame that has a probability of having been successfully received by a decoder above a predetermined threshold.

27. The method of claim 26, wherein the frame has an increased probability of having been successfully received by the decoder if the frame is small.

28. The method of claim 26, wherein the frame has an increased probability of having been successfully received by the decoder if forward error correction is implemented at the decoder.

29. The method of claim 26, wherein the frame has an increased probability of having been successfully received by the decoder if network conditions are adequate for a successful transmission.

30. A method of decoding video data, comprising:
decoding frames of a received video data; and
identifying a pixel block of a received frame as a refresh pixel block
wherein if the identified pixel block is in an edge-free area of the frame, a neighboring pixel block in the edge-free area of the frame is refreshed by interpolating the neighboring pixel block from the identified pixel block.

31. A video coder, comprising:
a coding engine to code input video data according to predictive coding techniques;
a reference picture cache to store decoded video data of coded reference frames, the reference picture cache storing data of long term reference (LTR) frames which have been acknowledged by a decoder and non-LTR frames;
a controller, to control operation of the coding engine and, responsive to an error resiliency policy, determine whether a pixel block in a frame is to be coded as a refresh pixel block; and
if the pixel block is to be coded as a refresh pixel block, cause the coding engine to code the pixel block according to predictive techniques with reference to a stored long term reference (LTR) frame; and
if the pixel block to not to be coded as a refresh pixel block, cause the coding engine to code the pixel block according to predictive coding techniques with reference to a reference frame.

32. The video coder of claim 31, wherein the error resiliency mandates that the controller code each pixel block location in a frame area as a refresh pixel block at a predetermined rate.

33. The video coder of claim 32, wherein the refresh rate of a given pixel block location is increased based on image content of the given pixel block.

34. The video coder of claim 32, wherein the refresh rate of a given pixel block location is increased when the given pixel block contains an edge.

35. The video coder of claim 32, wherein the refresh rate of a given pixel block location is increased when the given pixel block contains an object.

36. The video coder of claim 32, wherein the refresh rate of a given pixel block location is increased when the given pixel block contains image content classified as foreground content.

37. The video coder of claim 31, wherein the controller stores a refresh counter for each pixel block location in a frame area, and the controller evaluates the refresh counter for a pixel block in a frame to determine whether the pixel block is to be coded as a refresh pixel block and after the frame is coded, the controller identifies the pixel block(s) that have been coded predictively with reference to an LTR frame and resets the refresh counters of the identified pixel block(s).

38. A video decoder, comprising:
a decoding engine to decode input coded video data representing a long term reference (LTR) frame data;
a reference picture cache to store the decoded LTR frame data; and
a controller, to control operation of the decoding engine and to transmit an acknowledgement of the coded LTR frame data to an encoder;
wherein upon reception of coded video data representing a frame containing coded refresh pixel blocks, the refresh pixel blocks selected according to an error resiliency policy, decoding the coded refresh pixel blocks according to predictive decoding techniques, using the stored LTR frame data as a source of prediction.

39. The decoder of claim 38, wherein if the identified pixel block is in an edge-free zone of the frame, a neighboring pixel block in the edge-free zone of the frame is refreshed by interpolating the neighboring pixel block from the identified pixel block.
